(19) United States
(12) Patent Application Publication
(10) Pub. No.: US 2006/0117618 A1
(43) Pub. Date: Jun. 8, 2006

(54) Trading card having a breaking section

(75) Inventors: Wayne Wilcoxen, Carlsbad, CA (US); Martin Welling, Murrieta, CA (US)

Correspondence Address: THE LAW OFFICE OF STEVEN G ROEDER, 5560 CHELSEA AVE, LA JOLLA, CA, 92037, US

(73) Assignee: The Upper Deck Company

(21) Appl. No.: 11/003,638

(22) Filed: Dec. 3, 2004

(51) Int. Cl. G09F 1/00

(52) U.S. Cl. 40/124.191

(57) ABSTRACT

A collectible trading card (10) includes an outer card (12) and an insert card (14). The insert card (14) contains an insert card image (44). The outer card (12) includes a first region (38) and a second region (40). The first region (38) includes a card aperture (24) that receives at least a portion of the insert card (14). The second region (40) is moveable from a first position (41A) to a second position (41B). In the first position (41A), the insert card (14) is inhibited from being removed from the card aperture (24). In the second position (41B), the insert card (14) can be removed from the card aperture (24).

### BACKGROUND

Trading cards are a popular way to collect images and information about athletes and celebrities. Trading cards can also be used in card games and other activities. Unfortunately, many of the trading cards are manufactured in large quantities and are not very unique. Further, existing trading cards do not provide an element of mystery or surprise.

### SUMMARY

The present invention is directed to a trading card that includes a first insert card and an outer card. The first insert card contains a first insert card image. The outer card includes a first region and a second region. The first region includes a first card aperture that receives at least a portion of the first insert card. The second region is moveable from a first position in which the outer card is in an original condition to a second position in which the outer card is in an altered condition. In the first position the first insert card is inhibited from being removed from the first card aperture. In the second position the first insert card can be removed from the first card aperture.

In one embodiment, the outer card includes an outer card image. The outer card image can be altered during movement of the second section to the second position. Further, in one embodiment, movement of the second region to the second position permanently deforms the outer card. For example, a portion of the outer card will break during movement of the second region from the first position to the second position.

In one embodiment, the outer card includes a weakened area that separates the regions. The weakened area facilitates movement of the second region relative to the first region. For example, the weakened area can include a plurality of perforations in the outer card.

In one embodiment, at least a portion of the first insert card image is not visible when the first insert card is positioned in the outer card. For example, the entire first insert card image is not visible when the first insert card is positioned in the outer card.

Additionally, the trading card can include a second insert card that is positioned in a second card aperture of the second region. In this embodiment, when the second region is in the first position, the second insert card is inhibited from being removed from the second region, and when the second region is in the second position, the second insert card can be removed from the second region.

Moreover, the present invention is directed to a game that includes one or more trading cards.

### BRIEF DESCRIPTION OF THE DRAWINGS

The novel features of this invention, as well as the invention itself, both as to its structure and its operation, will be best understood from the accompanying drawings, taken in conjunction with the accompanying description, in which similar reference characters refer to similar parts, and in which:

FIG. 1A is a front perspective view of a trading card having features of the present invention with the trading card in an original condition;

FIG. 1B is a rear perspective view of a trading card of FIG. 1A with the trading card in an original condition;

FIG. 1C is a perspective view of the trading card of FIG. 1A with the trading card in the original condition in phantom and an altered condition;

FIG. 1D is a perspective view of the trading card of FIG. 1A with the trading card in the altered condition and an insert card removed;

FIG. 1E is an exploded perspective view of the trading card of FIG. 1A;

FIG. 1F is an exploded perspective view of the trading card prior to assembly;

FIG. 2A is a perspective view of another embodiment of a trading card having features of the present invention with the trading card in an original condition;

FIG. 2B is a perspective view of the trading card of FIG. 2A with the trading card in an altered condition;

FIG. 2C is a perspective view of the trading card of FIG. 2A with the trading card in the altered condition and a pair of insert cards removed; and

FIG. 3 is a perspective view of a game that includes a plurality of trading cards.

### DESCRIPTION

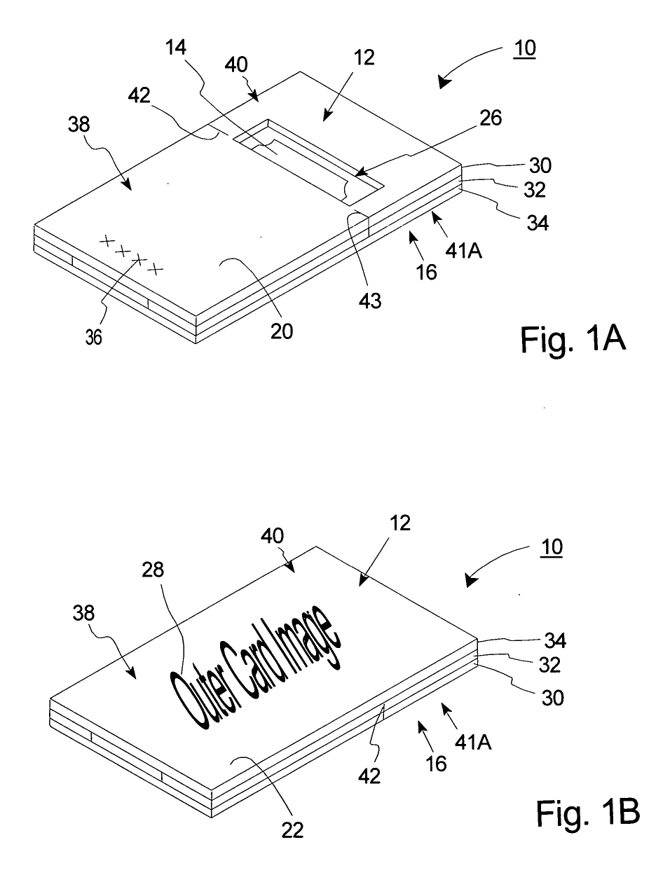

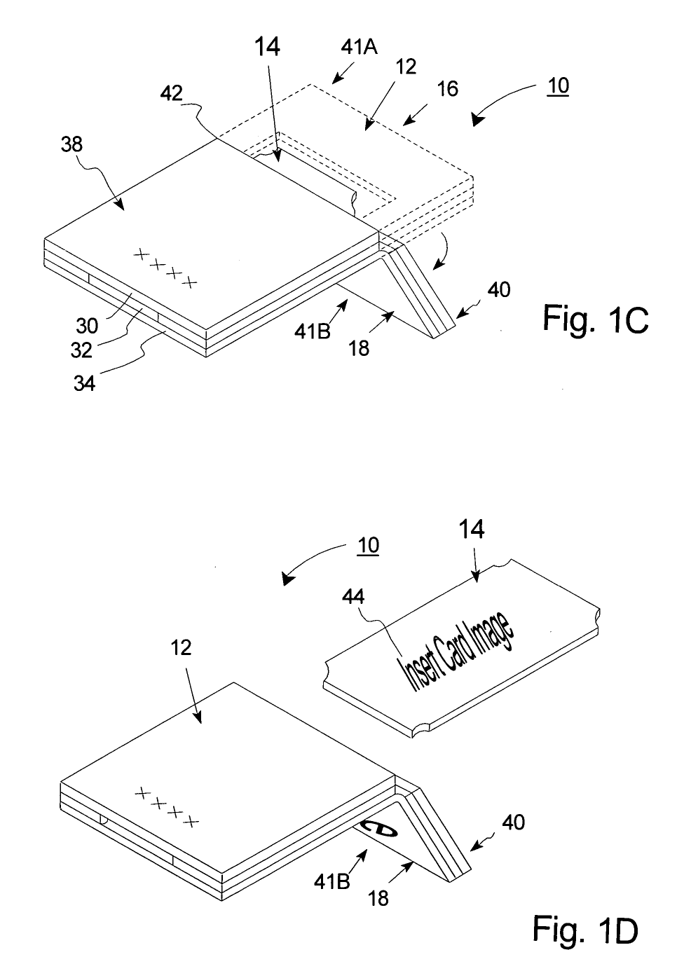

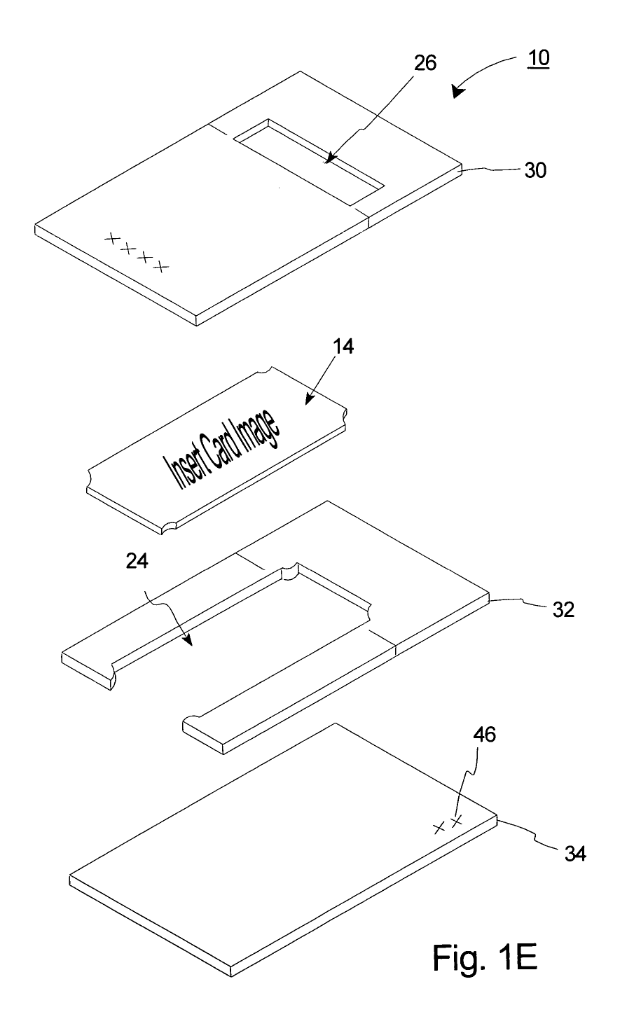

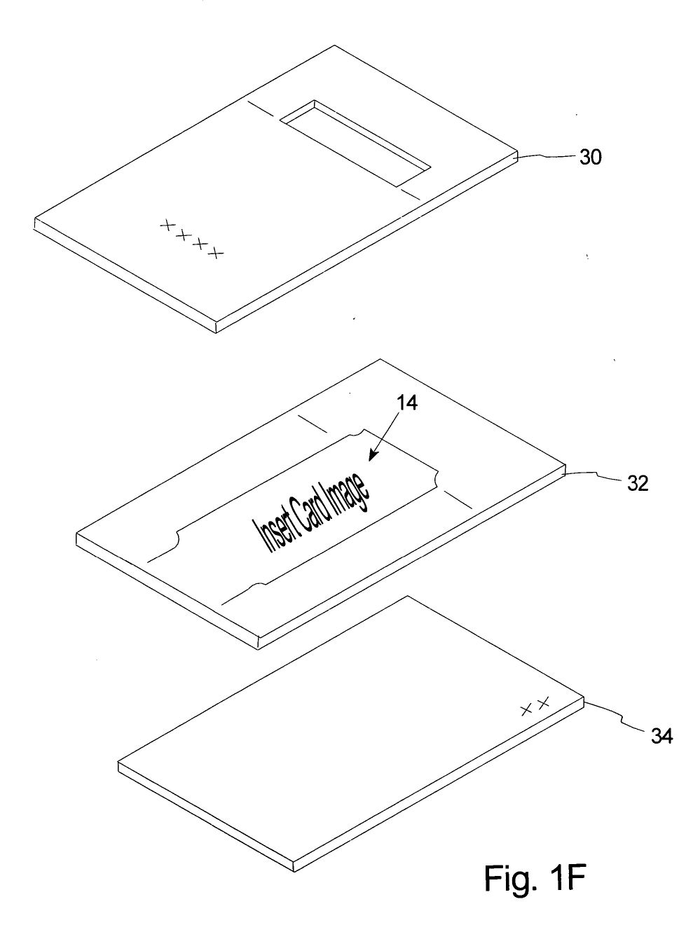

FIG. 1A is front perspective view and FIG. 1B is a rear perspective view of a trading card 10 having features of the present invention. The trading card 10 includes an outer card 12 and one or more insert cards 14 that are positioned at least partly within the outer card 12. The size and shape of these components can be varied to suit the desired design requirements of the trading card 10. Further, the number of insert cards 14 can be varied. In FIG. 1A, the trading card 10 includes one insert card 14. The trading card 10, for example, can be a collectible item or can be used is sports or entertainment games. For example, the trading card 10 can be used as a game play card or as an interactive sports card.

In FIGS. 1A and 1B, the assembled trading card 10 has the same dimensions as the outer card 12. In this embodiment, the outer card 12 is generally flat, rectangular shaped and has a length of between 2 and 6 inches, a width of between approximately 1.5 and 4.0 inches, and a thickness of between approximately 0.0625 and 0.25 inches. For example, the outer card 12 can be similarly sized and shaped as a standard trading card having a length of approximately 3.5 inches, a width of approximately 2.5 inches, and a thickness of between approximately 0.0625 and 0.1875 inches.

In one embodiment, the outer card 12 has an original condition 16 and an altered condition 18 (illustrated in FIGS. 1C and 1D). In the original condition 16, the outer card 12 retains the insert card 14, and/or encircles and encloses the insert card 14. In contrast, as described below, in the altered condition 18, the insert card 14 can be selectively removed from the outer card 12.

In one embodiment, the trading card 10 is manufactured and originally sold with the outer card 12 as a collectible item that is in its original condition 16. Subsequently, the purchaser, holder, or owner of the trading card 10 can decide to alter the outer card 12 and provide full access to the insert card 14, which is also a collectible item. In one embodiment, once the outer card 12 has been altered, it can never be fully returned to the original condition 16. In another design, once the outer card 12 has been altered, it can be returned to the original condition 16 or close to the original condition 16.

In FIGS. 1A and 1B, the outer card 12 includes a first side 20 and an opposed second side 22. Further, the outer card 12 defines a card aperture 24 (illustrated in FIG. 1E) that is sized and shaped to receive the insert card 14. In one embodiment, the card aperture 24 is disposed between the first side 20 and the second side 22.

Additionally, the outer card 12 can include a viewing aperture 26 that exposes a portion of the insert card 14. For example, the viewing aperture 26 can be generally rectangular shaped or can have another configuration. In one embodiment, the viewing aperture 26 exposes only portion of the insert card 14. With this design, a portion of the insert card 14 can be maintained secret.

Additionally, the outer card 12 can include one or more images. For example, the outer card 12 can include an outer card image 28 on the second side 22 of the outer card 12. Alternatively, the outer card 12 can include two or more outer card images 28. Further, the one or more outer card images 28 can be on the first side 20 and/or the second side 22. As non-exclusive examples, one or each outer card image 28 can be that of a sports athlete, a celebrity, an entertainer, statistics, information, instructions, a logo, a game field or arena, an image used in a game, data, a character, an autograph, an animal and/or landscape.

The materials utilized in and the components that form the outer card 12 can be varied. In FIGS. 1A and 1B, the outer card 12 includes a first body section 30, a second body section 32, and a third body section 34, and the insert card 14 is cut out of the second body section 32. In this design, the insert card 14 is positioned between and fully enclosed within the body sections 30, 34 when the outer card 14 is in the original condition 16. Alternatively, for example, one or more of the sections 30, 32, 34 can be integrated together, laminated, or glued together.

Moreover, the outer card 12 can include card information 36 relating to and/or explaining the outer card image 28, operation of the trading card 10, operation of a game associated with the trading card 10, and/or the company that manufactures or distributes the trading card 10.

In one embodiment, the outer card 12 can be divided into a first region 38 and a second region 40. Further, the second region 40 can be moved relative to the first region 38 from a first position 41A in which the outer card 12 is in the original condition 16 to a second position 41B (illustrated in FIGS. 1C, 1D) in which the outer card 12 is in the altered condition 18.

In FIG. 1A, the first region 38 defines the majority of the card aperture 24 (illustrated in FIG. 1E) and the insert card 14 is mainly positioned in the first region 38. When the outer card 12 is in the original condition 16 with the second region 40 in the first position 41A, the insert card 14 is inhibited from being removed from the outer card 12. In contrast, when the outer card 12 is in the altered condition 18 with the second region 40 in the second position 41B, the insert card 14 can be easily removed from the outer card 12.

In one embodiment, the outer card 12 is made in a fashion that facilitates the movement of the trading card 10 from the original condition 16 to the altered condition 18. For example, the outer card 12 can include a weakened area 42 that separates the regions 38, 40 to facilitate movement of the second region 40 relative to the first region 38. In one embodiment, the weakened area 42 is a cut in the outer card 12 that extends partly into the outer card 12 and that results in one or more small connection points 43. In FIG. 1A, the cuts extend into the first body section 30 and the second body section 32. Alternatively, for example, the weakened area 42 can include a plurality of perforations.

FIG. 1C is a perspective view of the trading card 10 with the outer card 12 in the original condition 16 (in phantom) and an altered condition 18. During movement of the second region 40 from the first position 41A to the second position 41B, the outer card 12 is partly broken along the weakened area 42 and the second region 40 has been rotated relative to the first region 38. More specifically, in this embodiment, the first body section 30 and the second body section 32 have been broken, and the third body section 34 has been bent during movement from the original condition 16 to the altered condition 18. Stated another way, with this design, rotation of the second region 40 relative to the first region 38 causes the first body section 30 and the second body section 32 to break. In this embodiment, the outer card 12 has been permanently damaged and can never be fully returned to the original condition 16.

FIG. 1D is a perspective view of the trading card 10 with the outer card 12 in the altered condition 18. In this condition, the second region 40 has been moved, and the insert card 14 can be readily removed from the outer card 12. It should be noted that once the outer card 12 is broken, the insert card 14 is released and can be removed.

In FIG. 1D, the insert card 14 is generally flat, rectangular plate shaped and is smaller in size than the outer card 12. Further, in one embodiment, the insert card 14 includes inwardly curved corners that inhibit the insert card 14 from sliding out the bottom of the trading card 10. Alternatively, the insert card 14 can have another configuration. In one embodiment, the insert card 14 has a length of between approximately 0.5 and 2 inches, and a width of between approximately 0.5 and 2.0 inches.

The insert card 14 can include one or more images. For example, in the embodiment illustrated in FIG. 1D, the insert card 14 includes an insert card image 44. Alternatively, the insert card 14 can include two or more insert card images 44. Further, the one or more insert card images 44 can be on the front side or the back side of the insert card 14. As non-exclusive examples, one or each insert card image 44 can be that of a sports athlete, a celebrity, an entertainer, statistics, information, instructions, a logo, a game field or arena, an image used in a game, data, a character, an autograph, an animal and/or landscape. For example, the insert card image 44 can reveal secret messages, record breaking photos, or game values, weapons, or players.

In one embodiment, the insert card image 44 is related to the outer card image 28 in some fashion. For example, each image 28, 44 can be of the same individual, character or can be on the same team, or each image 28, 44 can be used for the same or related game. Alternatively, each image 28, 44 can be unrelated.

Further, in this embodiment, referring to FIGS. 1C and 1D, the insert card image 44 is not visible when the insert card 14 is positioned within the outer card 12 and the insert card image 44 can only be viewed after permanently altering the outer card 12 and removing the insert card 14 from the outer card 12.

In should be noted that information regarding the manufacturer or the images can also be displayed on the card insert 14.

FIG. 1E is an exploded perspective view of the trading card 10 including the body sections 30, 32, 34 in greater detail. In this embodiment, each body section 30, 32, 34 is generally flat, rectangular plate shaped. In this embodiment, the first body section 30 includes the viewing aperture 26 that has been cut into the first body section 30. Further, the insert card 14 has been cut from the second body section 32 and removed from the rest of the second body section 32. After the insert card 14 has been removed, the second body section 32 defines the card aperture 24. With this design, the card aperture 24 is sized and shaped for receiving the insert card 14.

In this embodiment, the body sections 30, 32, 34 are each made of card stock. For example, the body sections 30, 32, 34 can be made of 24 points card stock.

In one embodiment, a section retainer 46 secures the body sections 30, 32, 34 together. For example, the section retainer 46 can be an adhesive. Alternatively, the body sections 30, 32, 34 can be laminated together.

FIG. 1F is an exploded perspective view of the body sections 30, 32, 34 prior to assembly. In particular, at this time each of the body sections 30, 32, 34 is slightly larger and the image card 14 has been cut in the second body section 32 but is partly attached to the rest of the second body section 32. Subsequently, the body sections 30, 32, 34 can be secured together. Next the perimeter of the assemblied body section 30, 32, 34 is cut. This detaches the image card 14 from the second body section 32.

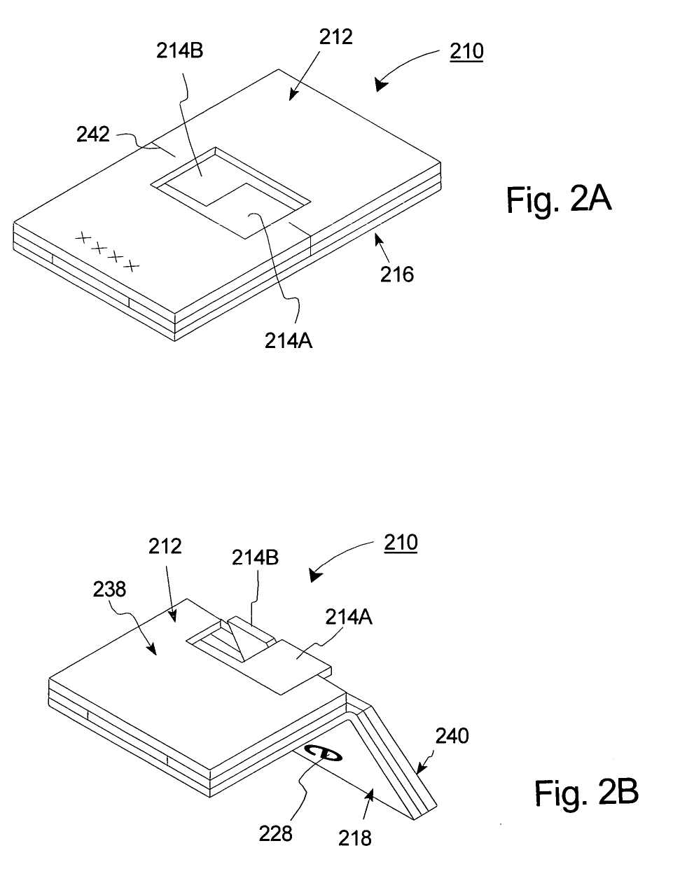

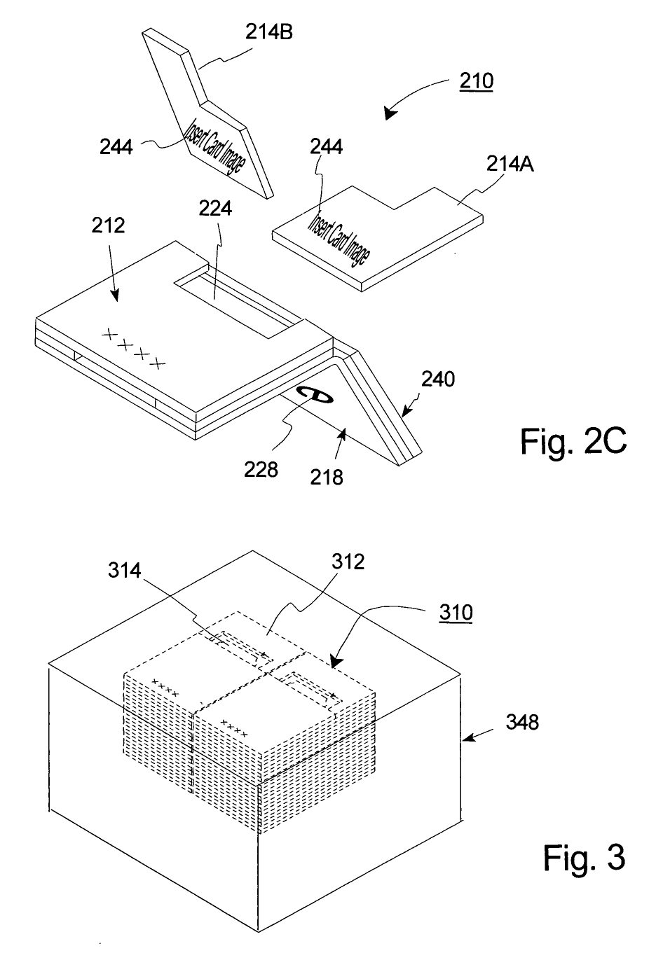

FIG. 2A is front perspective view of another embodiment of a trading card 210 having features of the present invention. The trading card 210 illustrated in FIG. 2A includes an outer card 212 in the original condition 216, and a first insert card 214A and a second insert card 214B that are positioned at least partly within the outer card 212. The outer card 212 and each insert card 214A, 214B can have similar features to the corresponding components described above. It should be noted that in the original condition 216, the insert cards 214A, 214B are inhibited from being removed from the outer card 212.

FIG. 2B is a perspective view of the trading card 210 with the outer card 212 in the altered condition 218. During movement from the original condition 216 to the altered condition 218, the outer card 212 is partly broken along the weakened area 242 (illustrated in FIG. 2A). Further, in this embodiment, the first insert card 214A is positioned in a first card aperture 224 (illustrated in FIG. 2C) in the first region 238 and the second insert card 214B is positioned in a second card aperture in the second region 240. It should be noted that in the altered condition 218, the insert cards 214A, 214B can be removed from the outer card 212.

Additionally, in FIG. 2B, the outer card 212 again includes an outer card image 228.

FIG. 2C is a perspective view of the trading card 210 with the outer card 212 in the altered condition 218. In this condition, the second region 240 has been moved, and the insert cards 214A, 214B can be readily removed from the outer card 212. Additionally, each insert card 214A, 214B can include one or more insert card images 244.

In one embodiment, each insert card image 244 is related to the outer card image 228 in some fashion. For example, each image 228, 244 can be of the same individual, character or can be on the same team, or each image 228, 244 can be used for the same or related game. Alternatively, each image 228, 244 can be unrelated. In one embodiment, for example, the one insert card image 244 reveals a value and the other insert card image 244 can double or triple the value or nullify the value.

Further, in this embodiment, referring to FIGS. 2B and 2C, each insert card image 244 is not visible when the insert card 214 is positioned within the outer card 212 and the insert card images 244 can only be viewed after permanently altering the outer card 212 and removing the insert cards 214A, 214B.

FIG. 3 is a perspective of a game 348 that includes a plurality of trading cards 310 (illustrated in phantom) having features similar to the trading cards described above. The type of game 348 which utilizes the trading cards 310 can vary. In one embodiment, the game 348 is a card type game. In one embodiment, the outer card 312 has no game value after it is altered. In this embodiment, the insert card 314 now has game value. Alternatively, the outer card 312 has a first game value and the insert card 314 has a second game value that may be more or less valuable than the outer card 312 before it has been altered.

In one version of the game, for example, during game play, the owner or holder of the trading card 310 may choose or be forced to break the outer card 312. The insert card 314 can contain secret information, message or instructions. With this design, only by deforming, e.g. breaking the outer card 312 can the secret information be obtained.

In another embodiment, the trading card 310 is a collectible item. In this embodiment, the original condition trading card 310 can have a certain collectible value. However, the collectible value of the insert card 314 may be the same, more or less valuable than the outer card 312 before it has been altered. Thus, the possibility of a greater or lesser valued insert card 14 exists. With this design, the altered condition outer card 312 is greatly diminished in collectible value. The original condition trading card 310 retains value or desirability because of the possibility of a greater return from the insert card 314.

It is to be understood that the trading cards 10 disclosed herein is merely illustrative of the presently preferred embodiments of the invention and that no limitations are intended to the details of construction or design herein shown other than as described in the appended claims.

What is claimed is:

1. A trading card comprising:
a first insert card that contains a first insert card image;
an outer card including a first region and a second region, the outer card including a first card aperture that receives at least a portion of the first insert card, the second region being moveable from a first position to a second position, in the first position the first insert card is inhibited from being removed from the outer card, and in the second position the first insert card can be removed from the outer card.

2. The trading card of claim 1 wherein the outer card includes an outer card image.

3. The trading card of claim 1 wherein movement of the second region to the second position permanently deforms the outer card.

4. The trading card of claim 3 wherein a portion of the outer card breaks during movement of the second region from the first position to the second position.

5. The trading card of claim 1 further comprising a weakened area that separates the regions, the weakened area facilitating movement of the second region relative to the first region.

6. The trading card of claim 5 wherein the weakened area includes a cut in the outer card.

7. The trading card of claim 1 further comprising a second insert card and wherein the outer card includes a second card aperture that receives at least a portion of the second insert card, wherein when the second region is in the first position, the second insert card is inhibited from being removed from the outer card and wherein when the second region is in the second position, the second insert card can be removed from the outer card.

8. The trading card of claim 1 wherein at least a portion of the first insert card image is not visible when the first insert card is positioned in the first card aperture.

9. The trading card of claim 1 wherein the entire first insert card image is not visible when the first insert card is positioned in the first card aperture.

10. A game including the trading card of claim 1.

11. A trading card comprising:
a first insert card that contains a first insert card image; and
an outer card including an outer card image, the outer card including a first region, a second region that is moveable from a first position to a second position, and a weakened area positioned between the regions that facilitates movement of the second region relative to the first region, the first region including a first card aperture that receives at least a portion of the first insert card, in the first position the first insert card is inhibited from being removed from the first card aperture, and in the second position, the first insert card can be removed from the first card aperture.

12. The trading card of claim 11 wherein movement of the second region to the second position permanently deforms the outer card.

13. The trading card of claim 12 wherein a portion of the outer card breaks during movement of the second region from the first position to the second position.

14. The trading card of claim 11 wherein the weakened area includes a cut in the outer card.

15. The trading card of claim 11 further comprising a second insert card and wherein the second region includes a second card aperture that receives at least a portion of the second insert card, wherein when the second region is in the first position, the second insert card is inhibited from being removed from the second region and wherein when the second region is in the second position, the second insert card can be removed from the second region.

16. The trading card of claim 11 wherein at least a portion of the first insert card image is not visible when the first insert card is positioned in the first card aperture.

17. The trading card of claim 11 wherein the entire first insert card image is not visible when the first insert card is positioned in the first card aperture.

18. A game including the trading card of claim 11.

19. A method for making a trading card, the method comprising the steps of:
providing an outer card that receives an insert card, the outer card having a first region and a second region; and
moving the second region from a first position where the insert card is inhibited from being removed from the card aperture to a second position where the insert card can be removed from the card aperture.

20. The method of claim 19 wherein the step of moving includes permanently deforming the outer card.

21. The method of claim 19 wherein the step of moving includes breaking a portion of the outer card.
